(19) United States
(12) Patent Application Publication
(10) Pub. No.: US 2016/0153790 A1
(43) Pub. Date: Jun. 2, 2016

(54) VEHICLE DRIVING INFORMATION ACQUISITION APPARATUS, ACQUISITION METHOD THEREOF, AND SERVICE SYSTEM USING VEHICLE DRIVING INFORMATION

(71) Applicant: Hyundai Motor Company, Seoul (KR)

(72) Inventors: Woo Chul Jung, Seoul (KR); Young Woo Choi, Incheon (KR)

(21) Appl. No.: 14/702,673

(22) Filed: May 2, 2015

(30) Foreign Application Priority Data
Nov. 27, 2014 (KR) 10-2014-0167291

(51) Int. Cl. G01C 21/34; G01S 19/13

(52) U.S. Cl. CPC G01C 21/34; G01S 19/13

(57) ABSTRACT

A vehicle driving information acquisition apparatus includes: a communication unit configured to receive a road tracking path from at least one vehicle equipped with a global positioning system (GPS) receiver, and a controller configured to correct the road tracking path received at the communication unit based on standard road information and to store the corrected road tracking path.

### CROSS-REFERENCE TO RELATED APPLICATION

This application claims priority to and the benefit of Korean Patent Application No. 10-2014-0167291, filed on Nov. 27, 2014, which is hereby incorporated by reference as if fully set forth herein.

### BACKGROUND

1. Technical Field

The present disclosure relates to a vehicle driving information acquisition apparatus, an acquisition method thereof, and a service system using vehicle driving information and, more particularly, to a vehicle driving information acquisition apparatus capable of changing erroneous global positioning system (GPS)-based driving information into valuable information, an acquisition method thereof, and a service system using acquired vehicle driving information.

2. Discussion of the Related Art

In modern society, drivers can conveniently and effectively navigate their vehicles to a desired destination using a navigation system equipped with a global positioning system (GPS) receiver. As known, a GPS receiver is adapted to perform communication with a plurality of satellites, and to allow a user to know a position of the GPS receiver. Currently, however, an error range of 5 meters or more can occur even if the GPS receiver receives radio waves from multiple satellites (e.g., five or more).

Although a variety of services directed to analysis of movement paths of vehicles and the like have been developed, the above-described limit to GPS technology may cause a difference in movement path, i.e., tracking path, even if vehicles follow the same path in the same manner. This may deteriorate reliability of resultant movement data and occasionally cause the data to be valueless. Accordingly, from the point of view of service providers who acquire and analyze tracking paths of vehicles, the acquired data has less usefulness even when large amounts of data are acquired.

### SUMMARY

The present disclosure is directed to a vehicle driving information acquisition apparatus, an acquisition method thereof, and a service system using vehicle driving information that substantially obviate one or more problems due to limitations and disadvantages of the related art.

An object of the present disclosure is to provide a vehicle driving information acquisition apparatus capable of correcting erroneous GPS-based driving information into valuable information, an acquisition method thereof, and a service system using acquired vehicle driving information. Additional advantages, objects, and features of the present disclosure will be set forth in part in the description which follows and in part will become apparent to those having ordinary skill in the art upon examination of the following or may be learned from practice of the disclosed embodiments. The objectives and other advantages of the present disclosure may be realized and attained by the structure particularly pointed out in the written description and claims hereof as well as the appended drawings.

To achieve these objects and other advantages and in accordance with the purpose of the present disclosure, as embodied and broadly described herein, the disclosed embodiments provide a vehicle driving information acquisition apparatus including: a communication unit configured to receive a road tracking path from at least one vehicle equipped with a global positioning system (GPS) receiver and a controller configured to correct the road tracking path received at the communication unit based on standard road information and to store the corrected road tracking path.

The controller may be further configured to divide the road tracking path received from the at least one vehicle into one or more sections and to correct the divided road tracking path such that each of the one or more sections corresponds to one link of the standard road information.

The controller may be further configured to divide the road tracking path received from the at least one vehicle into one or more sections and to set first road driving data in a first section of the one or more sections so as to correspond to a first link of the standard road information. Also, the controller may be further configured to select a link having directivity close to the first road driving data and second road driving data from among one or more links connectable to the first link and to connect the selected link to the first link, when the second road driving data within the first section does not correspond to the first link.

The controller may be further configured to transmit the corrected road tracking path stored therein to an external device via the communication unit.

Furthermore, according to embodiments of the present disclosure, a vehicle driving information acquisition method of a vehicle driving information acquisition server includes: receiving a road tracking path from at least one vehicle equipped with a GPS receiver; correcting the road tracking path received from the vehicle based on standard road information; and storing the corrected road tracking path.

The correcting of the road tracking path may include dividing the road tracking path received from the at least one vehicle into one or more sections and correcting the divided road tracking path such that each of the one or more sections corresponds to one link of the standard road information.

Furthermore, according to embodiments of the present disclosure, a vehicle driving information acquisition service system includes: a vehicle driving information acquisition apparatus configured to receive a road tracking path from at least one vehicle equipped with a GPS receiver and to correct the received road tracking path based on standard road information; and a service device configured to receive the corrected tracking path of the at least one vehicle from the vehicle driving information acquisition apparatus and to provide a client terminal with a service using vehicle driving information including the corrected tracking path.

Furthermore, according to embodiments of the present disclosure, a non-transitory computer readable medium containing program instructions for performing a vehicle driving information acquisition method of a vehicle driving information acquisition server includes: program instructions that correct a road tracking path received from at least one vehicle equipped with a GPS receiver based on standard road information; and program instructions that store the corrected road tracking path.

It is to be understood that both the foregoing general description and the following detailed description of the present disclosure are exemplary and explanatory and are intended to provide further explanation of the disclosed embodiments as claimed.

### BRIEF DESCRIPTION OF THE DRAWINGS

The accompanying drawings, which are included to provide a further understanding of the present disclosure and are incorporated in and constitute a part of this application, illustrate embodiments of the disclosure and together with the description serve to explain the principle of the disclosure. In the drawings:

FIG. 1 is a schematic view of a service providing system using vehicle driving information according to embodiments of the present disclosure;

FIG. 2 is a block diagram of a vehicle driving information acquisition apparatus according to embodiments of the present disclosure;

FIG. 3 is a table showing GPS receiving information of a driven vehicle according to embodiments of the present disclosure;

FIG. 4 is a view showing an embodiment of correcting a tracking path corresponding to measured GPS receiving information of FIG. 3 based on standard road information; and

FIG. 5 is a sequence view showing a vehicle driving information acquisition method of a vehicle driving information acquisition server according to embodiments of the present disclosure.

### DETAILED DESCRIPTION OF THE EMBODIMENTS

Reference will now be made in detail to the embodiments of the present disclosure, examples of which are illustrated in the accompanying drawings. In the drawings, the same or similar elements are denoted by the same reference numerals even though they are depicted in different drawings, and a detailed description of the same or similar elements will be omitted. The suffixes “module” and “unit” of elements herein are used for convenience of description and thus can be used interchangeably and do not have any distinguishable meanings or functions. In addition, in the following description of the embodiments disclosed herein, a detailed description of related known technologies will be omitted when it may make the subject matter of the embodiments disclosed herein rather unclear. In addition, the accompanying drawings have been made only for a better understanding of the embodiments disclosed herein and are not intended to limit technical ideas disclosed herein, and it should be understood that the accompanying drawings are intended to encompass all modifications, equivalents and substitutions included in the sprit and scope of the present disclosure,

The terms including “first,” “second,” and the like may be used to describe various elements, but the elements are not limited by the terms. The terms, if any, are used for distinguishing between one element and other elements.

It will be understood that when one element is referred to as being “connected to” or “accessed by” another element, one element may be “connected to” or “accessed by” another element via a further element although one element may be directly connected to or directly accessed by another element. On the other hand, it will be understood that when one element is referred to as being “directly connected to” or “directly accessed by” another element, there is no component between the mentioned elements. The singular forms are intended to include the plural forms as well, unless the context clearly indicates otherwise.

The term “comprises” or “has” described herein should be interpreted not to exclude presence or addition possibility of characteristics, numbers, steps, operations, constituent elements, parts or combinations thereof described in the specification but to designate presence of one or more other characteristics, numbers, steps, operations, constituent elements, parts or combinations thereof.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

Furthermore, the controller of the present disclosure may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

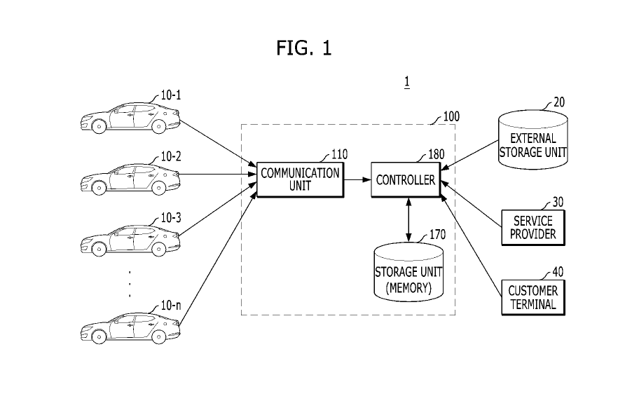

Referring now to the disclosed embodiments, FIG. 1 is a schematic view of a service providing system using vehicle driving information according to embodiments of the present disclosure. As shown in FIG. 1, a vehicle driving information system, designated by reference numeral 1, may include at least one vehicle 10-1 to 10-n equipped with a GPS receiver, a vehicle driving information acquisition apparatus 100, an external storage unit 20, a service provider 30, and a customer terminal 40.

The at least one vehicle (hereinafter referred to as a “vehicle”) 10-1 to 10-n equipped with a GPS receiver may receive geographical information from a plurality of satellites. The geographical information may include latitudes, longitudes, dates and time of measurement. A position of the vehicle 10-1 to 10-n equipped with a GPS receiver may be determined based on the geographical information. Note that a GPS may cause an error range of a given distance.

The vehicle driving information acquisition apparatus 100 may acquire vehicle driving path, i.e., vehicle tracking path information, from the vehicle 10-1 to 10-n equipped with a GPS receiver. The vehicle driving information acquisition apparatus 100 may include a communication unit 110, a controller 180, and a storage unit 170. The respective components will be described below in detail. The vehicle driving information acquisition apparatus 100 may be installed in a telematics service center.

The external storage unit 20 may receive and store vehicle tracking path information from the vehicle driving information acquisition apparatus 100. The external storage unit 20 may be an external server.

The service provider 30 may receive vehicle driving information from the vehicle driving information acquisition apparatus 100 and provide services using the same. For example, the service provider 30 may provide services with regard to the number of vehicles that move on a specific road, an average fuel efficiency of the vehicles, and an average velocity of the vehicles.

The customer terminal 40 may receive and use vehicle driving information from the vehicle driving information acquisition apparatus 100.

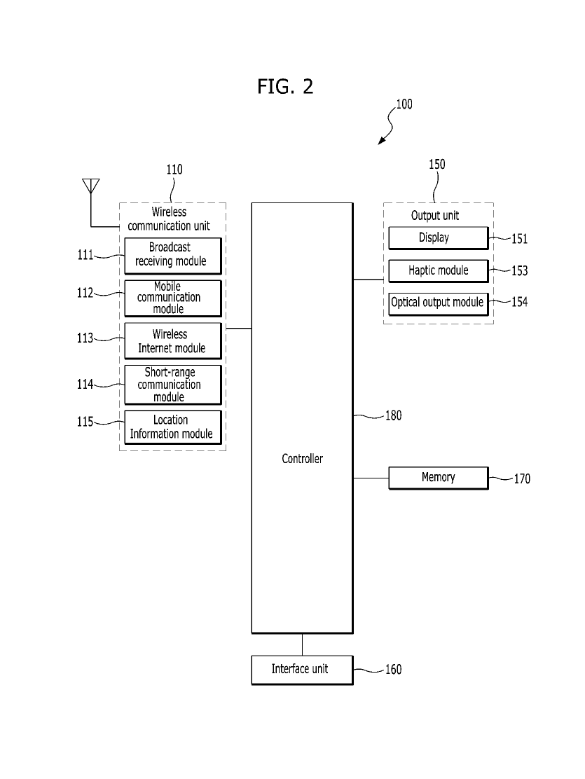

FIG. 2 is a block diagram of the vehicle driving information acquisition apparatus according to embodiments of the present disclosure.

The vehicle driving information acquisition apparatus 100 may include the wireless communication unit 110, an output unit 150, an interface unit 160, the memory 170, and the controller 180. The components shown in FIG. 2 may not be necessary to construct the vehicle driving information acquisition apparatus 100 and the vehicle driving information acquisition apparatus 100 as described herein may include a different number of components than the aforementioned components.

More specifically, among the aforementioned components, the wireless communication unit 110 may include one or more modules to enable wireless communication between the vehicle driving information acquisition apparatus 100 and a wireless communication system, between the vehicle driving information acquisition apparatus 100 and another vehicle driving information acquisition apparatus 100, or between the vehicle driving information acquisition apparatus 100 and an external server. In addition, the wireless communication unit 110 may include one or more modules to connect the vehicle driving information acquisition apparatus 100 to one or more networks. To this end, the wireless communication unit 110 may include at least one of a broadcast receiving module 111, a mobile communication module 112, a wireless Internet module 113, a near field communication module 114, and a position information module 115.

The interface unit 160 serves as a passage between the vehicle driving information acquisition apparatus 100 and various kinds of external appliances connected to the vehicle driving information acquisition apparatus 100.

The memory 170 stores data to aid various functions of the vehicle driving information acquisition apparatus 100. The memory 170 may store a number of applications to be executed in the vehicle driving information acquisition apparatus 100, and data and commands for operation of the vehicle driving information acquisition apparatus 100.

The controller 180 controls general operations of the vehicle driving information acquisition apparatus 100 as well as operations related to the applications. The controller 180 may process signals, data and information input or output through the aforementioned components or drive the applications stored in the memory 170, thereby providing the user with appropriate information or functions. In addition, the controller 180 may control at least some of the aforementioned components in FIG. 2 in order to drive the applications stored in the memory 170. To drive the applications, the controller 180 may combine and operate at least two or more components among the components included in the vehicle driving information acquisition apparatus 100.

At least some of the aforementioned components may operate in cooperation with one another in order to realize operation or control of the vehicle driving information acquisition apparatus 100 according to embodiments that will be described below. In addition, operation or control of the vehicle driving information acquisition apparatus 100 may be implemented by the vehicle driving information acquisition apparatus 100 via driving of at least one application stored in the memory 170.

A display 151 displays (i.e., outputs) information processed in the vehicle driving information acquisition apparatus 100. For example, the display 151 may display execution screen information of the application driven in the vehicle driving information acquisition apparatus 100, or user interface (UI) and graphical user interface (GUI) information depending on the execution screen information.

Meanwhile, there may be provided identity modules in the form of chips that store information to authenticate use authority of the vehicle driving information acquisition apparatus 100. Examples of the identity modules may include a user identity module (UIM), a subscriber identity module (SIM), and a universal subscriber identity module (USIM). A device equipped with an identity module (hereinafter referred to as an “identity device”) may be fabricated into a smart card form. Accordingly, the identity device may be connected to the apparatus 100 via the interface unit 160.

In addition, the interface unit 160 may serve as a passage through which power is supplied from an external cradle to the vehicle driving information acquisition apparatus 100 when the vehicle driving information acquisition apparatus 100 is connected to the cradle, or may serve as a passage through which various command signals input from the cradle by a user are transmitted to the vehicle driving information acquisition apparatus 100. The various command signals or power input from the cradle may be operated as signals to assist the user in recognizing that the vehicle driving information acquisition apparatus 100 is accurately mounted to the cradle.

The memory 170 may include at least one storage medium selected from among a flash memory type memory, a hard disk type memory, a solid state disk (SSD) type memory, a silicon disk drive (SDD) type memory, a multimedia card micro type memory, a card type memory (for example, an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like.

Meanwhile, as described above, the controller 180 typically controls operation related to the applications and general operations of the vehicle driving information acquisition apparatus 100. For example, the controller 180 may execute or release a lock state to limit input of a user control command to applications when a state of the vehicle driving information acquisition apparatus 100 satisfies a preset condition.

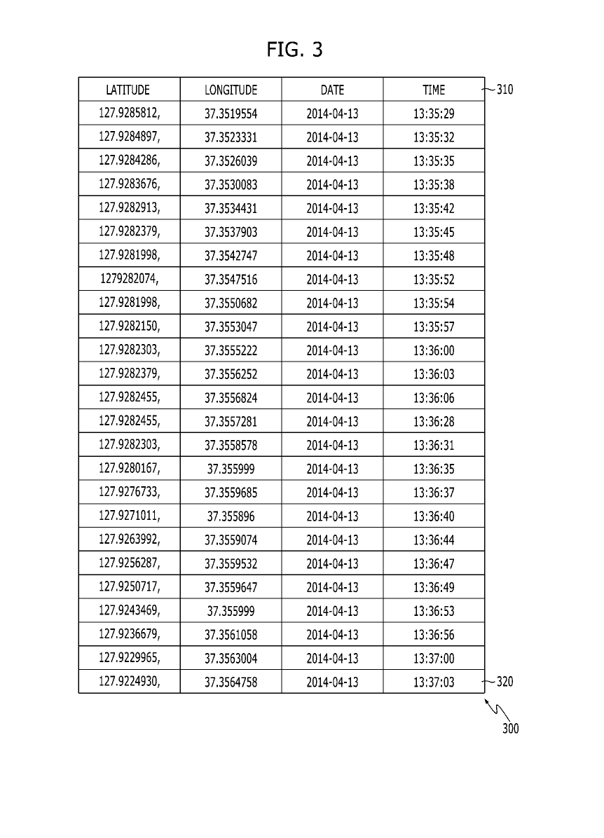

FIG. 3 is a table showing a real tracking path of a vehicle equipped with a GPS receiver according to embodiments of the present disclosure. As shown in FIG. 3, table 300 shows real-time position information of a vehicle equipped with a GPS receiver. More specifically, the GPS receiver equipped in the vehicle may receive signals from satellites. In this case, the GPS receiver may notify a position of the vehicle. Position information may include latitudes, longitudes, dates, and time. The flow of time may be represented in a direction from a top 310 to a bottom 320 of the table.

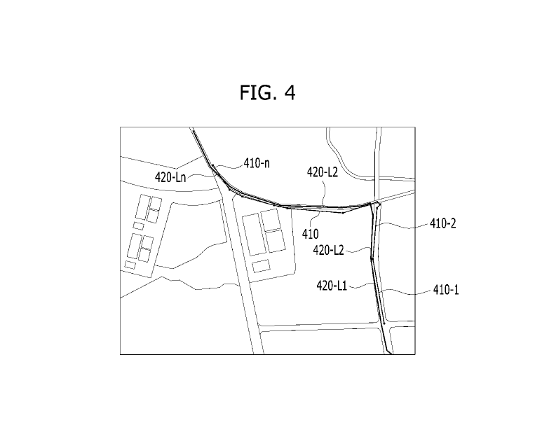

FIG. 4 is a view showing embodiments of correcting a tracking path corresponding to measured GPS receiving information of FIG. 3 based on standard road information. As shown in FIG. 4, reference numeral 410 denotes a real tracking path drawn on a map based on real-time GPS receiving information, and reference numeral 420 denotes a virtual tracking path based on standard road information as compared to the real tracking path 410.

In this case, even if the same vehicle follows the same path, the real tracking path 410 drawn on the map based on GPS receiving information may have an error whenever measured due to limits to GPS technology. The erroneous information has deteriorated value as information. For example, upon calculation of an average velocity/average fuel efficiency of a vehicle within a predetermined distance range, inaccuracy of GPS information may cause different calculation results. The present invention may overcome this limit.

The controller 180 may correct the road tracking path 410 received via the communication unit 110 based on standard road information 420 and store the corrected road tracking path. The standard road information 420 may include road link standard data of a geographic information system (GIS). The standard road information 420 may include various other standard road information. The controller 180 may correct the real tracking path based on GPS receiving information via comparison with standard road information.

In this case, the controller 180 may be connected to a server that provides standard road information in order to receive the standard road information. To this end, the controller 180 may control communication between the standard road information providing server and the communication unit 110. In addition, the controller 180 may directly receive standard road information via wireless communication with the standard road information providing server.

A more detailed description related to a method of correcting the road tracking path is as follows. As exemplarily shown in FIG. 4, the controller 180 may divide a road tracking path received from at least one vehicle into one or more sections 410-1, 410-2, . . . , 410-n, and correct the road tracking path such that the sections 410-1, 410-2, . . . , 410-n correspond to links 420-L1, 420-L2, 410-Ln of standard road information in a one to one ratio. For example, the controller 180 may delimit the first section 410-1 of the real tracking path 410 based on latitude and longitude values. While a range of the first section 410-1 may be arbitrarily set, preferably, the first section 410-1 corresponds to one link (e.g., 420-L1) of standard road information. Furthermore, the controller 180 may set position information of the first section 410-1 to the n^{th} section 410-n to correspond to the first link 420-L1 to the n^{th} link 420-Ln of standard road information in a one to one ratio. The controller 180 may correct the first section 410-1 to information of the n^{th} section 410-n into the first link 420-L1 to the n^{th} link 420-Ln.

Meanwhile, when first GPS road driving data, acquired when the vehicle really follows the first section 410-1, is included in the first link 420-L1, the controller 180 may match the first GPS road driving data with the first link 420-L1. In this case, when second GPS road driving data, acquired when the vehicle really follows the first section 410-1, is not included in the first link 420-L1, any one link having directivity close to the second GPS road driving data may be selected from among links that are connectable to the first link 420-L1 and then be connected to the first link 420-L1. For example, a link having directivity close to the first GPS road driving data and the second GPS road driving data may be connected to the first link 420-L1.

The corrected tracking path of the corresponding vehicle may be stored in the memory 170. In this way, GPS-based tracking paths of plural vehicles may be corrected and stored based on standard road information. The stored information may be processed in various ways so as to used in a variety of services. The controller 180 may transmit the corrected road tracking path stored in the memory 170 to an external device via the wireless communication unit 110. The transmitted information may be used by or stored in the external device.

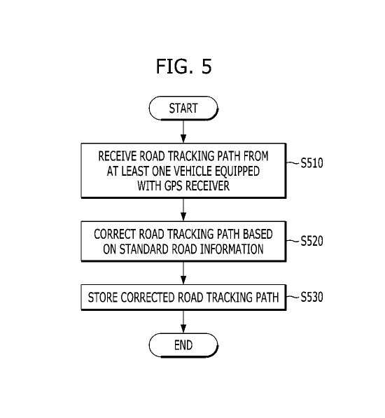

FIG. 5 is a sequence view showing a vehicle driving information acquisition method of a vehicle driving information acquisition server according to embodiments of the present disclosure.

First, a road tracking path is received from at least one vehicle equipped with a GPS receiver (S510).

Next, the road tracking path received from the vehicle is corrected based on standard road information (S520).

Thereafter, the corrected road tracking path is stored (S530).

Meanwhile, a vehicle driving information acquisition service system according to embodiments of the present disclosure may include the vehicle driving information acquisition apparatus 100 that receives a road tracking path from at least one vehicle equipped with a receiver and corrects the received road tracking path based on standard road information, and a service device that receives the corrected tracking path of the vehicle from the acquisition apparatus 100 and provides a client terminal with a service using vehicle driving information including the corrected tracking path. Here, the client terminal may correspond to a terminal capable of performing various wired/wireless communication, and the service device that receives the road tracking path from the vehicle driving information acquisition apparatus 100 and provides the client terminal with a service using the road tracking path may correspond to a service provider.

Accordingly, the above detailed description is not intended to be construed to limit the present disclosure in all aspects and be considered by way of example. The scope of the present disclosure should be determined by reasonable interpretation of the accompanying claims and all equivalent modifications made without departing from the present disclosure should be included in the following claims.

As is apparent from the above description, according to embodiments of the present disclosure, by using the vehicle driving information acquisition techniques described herein, in which erroneous GPS-based driving information is corrected into valuable information, efficient use of the acquired information may be accomplished. It will be appreciated by persons skilled in the art that the effects that can be achieved through the present disclosure are not limited to what has been particularly described hereinabove and other advantages of the present disclosure will be more clearly understood from the above detailed description.

It will be apparent to those skilled in the art that various modifications and variations can be made in the present disclosure without departing from the spirit or scope of the disclosed embodiments. Thus, it is intended that the present disclosure covers the modifications and variations of the embodiments herein provided they come within the scope of the appended claims and their equivalents.

What is claimed is:

1. A vehicle driving information acquisition apparatus comprising:
a communication unit configured to receive a road tracking path from at least one vehicle equipped with a global positioning system (GPS) receiver; and
a controller configured to correct the road tracking path received at the communication unit based on standard road information and to store the corrected road tracking path.

2. The apparatus according to claim 1, wherein the controller is further configured to divide the road tracking path received from the at least one vehicle into one or more sections and to correct the divided road tracking path such that each of the one or more sections corresponds to one link of the standard road information.

3. The apparatus according to claim 1, wherein:
the controller is further configured to divide the road tracking path received from the at least one vehicle into one or more sections and to set first road driving data in a first section of the one or more sections so as to correspond to a first link of the standard road information, and
the controller is further configured to select a link having directivity close to the first road driving data and second road driving data from among one or more links connectable to the first link and to connect the selected link to the first link, when the second road driving data within the first section does not correspond to the first link.

4. The apparatus according to claim 1, wherein the controller is further configured to transmit the corrected road tracking path stored therein to an external device via the communication unit.

5. A vehicle driving information acquisition method of a vehicle driving information acquisition server, the method comprising:
receiving a road tracking path from at least one vehicle equipped with a GPS receiver;
correcting the road tracking path received from the vehicle based on standard road information; and
storing the corrected road tracking path.

6. The method according to claim 5, wherein the correcting of the road tracking path comprises dividing the road tracking path received from the at least one vehicle into one or more sections and correcting the divided road tracking path such that each of the one or more sections corresponds to one link of the standard road information.

7. A vehicle driving information acquisition service system comprising:
a vehicle driving information acquisition apparatus configured to receive a road tracking path from at least one vehicle equipped with a GPS receiver and to correct the received road tracking path based on standard road information; and
a service device configured to receive the corrected tracking path of the at least one vehicle from the vehicle driving information acquisition apparatus and to provide a client terminal with a service using vehicle driving information including the corrected tracking path.

8. A non-transitory computer readable medium containing program instructions for performing a vehicle driving information acquisition method of a vehicle driving information acquisition server, the computer readable medium comprising:
program instructions that correct a road tracking path received from at least one vehicle equipped with a GPS receiver based on standard road information; and
program instructions that store the corrected road tracking path.
